(19) United States
(12) Patent Application Publication
(10) Pub. No.: US 2023/0023869 A1
(43) Pub. Date: Jan. 26, 2023

(54) SYSTEM AND METHOD FOR PROVIDING INTELLIGENT ASSISTANCE USING A WARRANTY BOT

(71) Applicant: Dell Products, L.P., Round Rock, TX (US)

(72) Inventors: Vaideeswaran Ganesan, Bangalore (IN); Chandrasekhar R, Bangalore (IN); Nidhi Kant Arora, Bangalore (IN)

(73) Assignee: Dell Products, L.P., Round Rock, TX (US)

(21) Appl. No.: 17/409,835

(22) Filed: Aug. 24, 2021

(30) Foreign Application Priority Data
Jul. 23, 2021 (IN) 202111033236

(51) Int. Cl. G06Q 30/00; G06Q 10/00; G06F 16/245; H04L 12/58

(52) U.S. Cl. CPC G06Q 30/012; G06Q 10/20; G06F 16/245; H04L 51/046; H04L 51/02

(57) ABSTRACT

Systems and methods are disclosed for a specialized warranty bot that can interact with users to evaluate warranty coverage. A warranty interpreter interprets warranty aspects of a given system and converts the warranty terms it into human understandable text. A situation analyzer enhances warranty interpretation by scanning logs across various components that are covered by the warranty and identifying whether the current problems are covered by the warranty. Assessment guidance processing anticipates questions from the customer and provides information regarding why a problem may not be covered by the warranty. Using a solution advisor, based on the problem details and historical analysis, the warranty bot provides insights regarding potential minimum time for resolution of a problem in order to assist the user to decide whether the system needs to be isolated or if the system can remain in production in a non-critical path.

### CROSS REFERENCE TO RELATED APPLICATIONS

This patent application claims priority to co-pending, commonly assigned Indian Patent Application No. 202111033236, filed Jul. 23, 2021 and entitled “System and Method for Providing Intelligent Assistance Using a Warranty Bot,” the entire contents of which are incorporated by reference herein.

### FIELD

The present disclosure generally relates to Information Handling Systems (IHSs) and, more particularly, to providing customer-friendly assistance for IHS warranties using a BOT.

### BACKGROUND

As the value and use of information continues to increase, individuals and businesses seek additional ways to process and store information. One option available to users is Information Handling Systems (IHSs). An IHS generally processes, compiles, stores, and/or communicates information or data for business, personal, or other purposes thereby allowing users to take advantage of the value of the information. Because technology and information handling needs and requirements vary between different users or applications, IHSs may also vary regarding what information is handled, how the information is handled, how much information is processed, stored, or communicated, and how quickly and efficiently the information may be processed, stored, or communicated. The variations in IHSs allow for IHSs to be general or configured for a specific user or specific use such as financial transaction processing, airline reservations, enterprise data storage, or global communications. In addition, IHSs may include a variety of hardware and software components that may be configured to process, store, and communicate information and may include one or more computer systems, data storage systems, and networking systems.

Groups of IHSs may be housed within data center environments. A data center may include a large number of IHSs, such as enterprise blade servers that are stacked and installed within racks. A data center may include large numbers of such server racks that are organized into rows of racks. Administration of such large groups of IHSs may require teams of remote and local administrators working in shifts in order to support around-the-clock availability of the data center operations while minimizing any downtime. A data center may include a wide variety of hardware systems and software applications that may each be separately covered by warranties. The information available regarding warranties can be confusing for customers to understand the support level available for various IHSs in a data center.

### SUMMARY

In various embodiments, systems and methods provide a specialized warranty bot that can interact with users to evaluate warranty coverage. The warranty bot may initiate a conversation with a user, such as an IT administrator, upon identifying a system problem. Alternatively, the user may initiate a conversation with the warranty bot to obtain warranty details while troubleshooting a system problem. The warranty bot comprises various AI processors and knowledgebases that support warranty interpretation and application of the warranty to a current problem. A warranty interpreter interprets warranty aspects of a given system and converts the warranty terms it into human understandable text. A situation analyzer enhances warranty interpretation by scanning logs across various components that are covered by the warranty and identifying whether the current problems are covered by the warranty. Assessment guidance processing anticipates questions from the customer and provides information regarding why a problem may not be covered by the warranty. This is accomplished by analyzing warranty artifacts, such as terms and conditions, and provides insights into whether a problem may not be covered due to warranty expiration, etc. Using a solution advisor, based on the problem details and historical analysis, the warranty bot provides insights regarding potential minimum time for resolution of a problem in order to assist the user to decide whether the system needs to be isolated or if the system can remain in production in a non-critical path.

### BRIEF DESCRIPTION OF THE DRAWINGS

The present invention(s) is/are illustrated by way of example and is/are not limited by the accompanying figures. Elements in the figures are illustrated for simplicity and clarity and have not necessarily been drawn to scale.

FIG. 1 is a block diagram illustrating certain components of a chassis supporting a plurality of IHSs and configured according to various embodiments for support of warranty bot.

FIG. 2 illustrates a warranty bot system 200 for interacting with users to provide IHS warranty information.

FIG. 3 illustrates an example interaction between a warranty bot and a user.

### DETAILED DESCRIPTION

A data center may include a large number of IHSs that may be installed as components of a chassis. A rack structure may house several different chassis, and a data center may include numerous racks. Components of the IHSs may be provided by multiple vendors and may be installed at different times. Accordingly, data center administrators face significant difficulties in assessing the current warranty coverage of the components within the data center. A data center may include a large number of licensed hardware and software systems. Upon expiration of warranty coverage, such data center hardware and software systems are no longer supported by their manufacturer, seller, re-seller, or other entity that has been contracted to provide support. In some scenarios, a hardware and software system this is out of warranty may impact the ability of the data center to provide a contracted service level agreements (SLA) with customers. Embodiments provide capabilities for consolidating warranty information that can be displayed seamlessly to data center administrators.

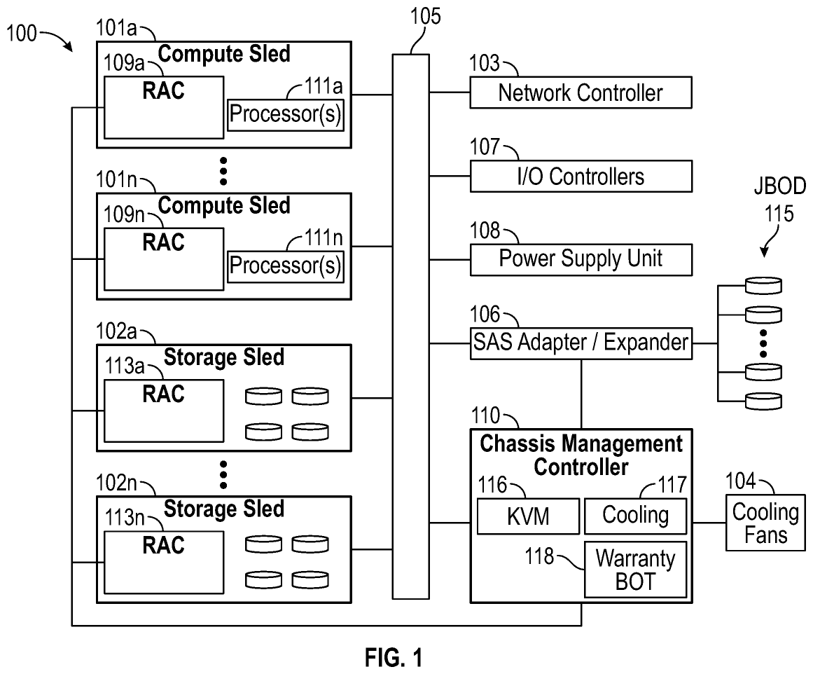

FIG. 1 is a block diagram illustrating certain components of a chassis 100 comprising one or more compute sleds 101a-n and one or more storage sleds 102a-n that may be configured to implement the systems and methods described herein. As described in additional detail below, each of the sleds 101a-n, 102a-n may be separately licensed hardware components and each of the sleds may also operate using a variety of licensed hardware and software features. Chassis 100 may include one or more bays that each receive an individual sled (that may be additionally or alternatively referred to as a tray, blade, and/or node), such as compute sleds 101a-n and storage sleds 102a-n. Chassis 100 may support a variety of different numbers (e.g., 4, 8, 16, 32), sizes (e.g., single-width, double-width), and physical configurations of bays. Other embodiments may include additional types of sleds that provide various types of storage and/or processing capabilities. Other types of sleds may provide power management and networking functions. Sleds may be individually installed and removed from the chassis 100, thus allowing the computing and storage capabilities of a chassis to be reconfigured by swapping the sleds with different types of sleds, in many cases without affecting the operations of the other sleds installed in the chassis 100.

By configuring a chassis 100 with different sleds, the chassis may be adapted to support specific types of operations, thus providing a computing solution that is directed toward a specific type of computational task. For instance, a chassis 100 that is configured to support artificial intelligence computing solutions may include additional compute sleds, compute sleds that include additional processors, and/or compute sleds that include specialized artificial intelligence processors or other specialized artificial intelligence components, such as specialized FPGAs. In another example, a chassis 100 configured to support specific data mining operations may include network controllers 103 that support high-speed couplings with other similarly configured chassis, thus supporting high-throughput, parallel-processing computing solutions.

In another example, a chassis 100 configured to support certain database operations may be configured with specific types of storage sleds 102a-n that provide increased storage space or that utilize adaptations that support optimized performance for specific types of databases. In other scenarios, a chassis 100 may be configured to support specific enterprise applications, such as by utilizing compute sleds 101a-n and storage sleds 102a-n that include additional memory resources that support simultaneous use of enterprise applications by multiple remote users. In another example, a chassis 100 may include compute sleds 101a-n and storage sleds 102a-n that support secure and isolated execution spaces for specific types of virtualized environments. In some instances, specific combinations of sleds may comprise a computing solution, such as an artificial intelligence system, that may be licensed and supported as a computing solution.

Multiple chassis 100 may be housed within a rack. Data centers may utilize large numbers of racks, with various different types of chassis installed in the various rack configurations. The modular architecture provided by the sleds, chassis, and rack allow for certain resources, such as cooling, power, and network bandwidth, to be shared by the compute sleds 101a-n and the storage sleds 102a-n, thus providing efficiency improvements, and supporting greater computational loads.

Chassis 100 may be installed within a rack structure that provides all or part of the cooling utilized by chassis 100. For airflow cooling, a rack may include one or more banks of cooling fans that may be operated to ventilate heated air away from a chassis 100 that is housed within a rack. Chassis 100 may alternatively or additionally include one or more cooling fans 104 that may be similarly operated to ventilate heated air from within the sleds 101a-n, 102a-n installed within the chassis. A rack and a chassis 100 installed within the rack may utilize various configurations and combinations of cooling fans 104 to cool the sleds 101a-n, 102a-n and other components housed within chassis 100.

Sleds 101a-n, 102a-n may be individually coupled to chassis 100 via connectors. The connectors may correspond to bays provided in the chassis 100 and may physically and electrically couple an individual sled 101a-n, 102a-n to a backplane 105. Chassis backplane 105 may be a printed circuit board that includes electrical traces and connectors that are configured to route signals between the various components of chassis 100. In various embodiments, backplane 105 may include various additional components, such as cables, wires, midplanes, backplanes, connectors, expansion slots, and multiplexers. In certain embodiments, backplane 105 may be a motherboard that includes various electronic components installed thereon. In some embodiments, components installed on a motherboard-type backplane 105 may include components that implement all or part of the functions described with regard to components such as network controller 103, SAS (Serial Attached SCSI) adapter/expander 106, I/O controllers 107, and power supply unit 108.

In certain embodiments, a compute sled 101a-n may be an IHS. A compute sled 101a-n may provide computational processing resources that may be used to support a variety of e-commerce, multimedia, business, and scientific computing applications. In some cases, these applications may be provided as services via a cloud implementation. Compute sleds 101a-n are typically configured with hardware and software that provide leading-edge computational capabilities. Accordingly, services provided using such computing capabilities are typically provided as high-availability systems that operate with minimum downtime. Compute sleds 101a-n may be configured for general-purpose computing or may be optimized for specific computing tasks in support of specific computing solutions. A compute sled 101a-n may be a licensed component of a data center and may also operate using various licensed hardware and software systems.

As illustrated, each compute sled 101a-n includes a remote access controller (RAC) 109a-n. A remote access controller 109a-n provides capabilities for remote monitoring and management of each compute sled 101a-n. In support of these monitoring and management functions, remote access controllers 109a-n may utilize both in-band and sideband (i.e., out-of-band) communications with various internal components of a compute sled 101a-n and with other components of chassis 100. Remote access controller 109a-n may collect sensor data, such as temperature sensor readings, from components of the chassis 100 in support of airflow cooling of the chassis 100 and the sleds 101a-n, 102a-n. Remote access controllers 109a-n may support communications with chassis management controller 110 where these communications may report on the status hardware and software systems on a particular sled 101a-n, 102a-n, such as information regarding warranty coverage for a particular hardware and/or software system.

A compute sled 101a-n may include one or more processors 111a-n that support specialized computing operations, such as high-speed computing, artificial intelligence processing, database operations, parallel processing, graphics operations, streaming multimedia, and/or isolated execution spaces for virtualized environments. Using such specialized processor capabilities of a compute sled 101a-n, a chassis 100 may be adapted for a particular computing solution.

In some embodiments, each compute sled 101a-n may include a storage controller that may be utilized to access storage drives that are accessible via chassis 100. Some of the individual storage controllers may provide support for RAID (Redundant Array of Independent Disks) configurations of logical and physical storage drives, such as storage drives provided by storage sleds 102a-n. In some embodiments, some or all of the individual storage controllers utilized by compute sleds 101a-n may be HBAs (Host Bus Adapters) that provide more limited capabilities in accessing physical storage drives provided via storage sleds 102a-n and/or via SAS expander 106.

As illustrated, chassis 100 also includes one or more storage sleds 102a-n that are coupled to the backplane 105 and installed within one or more bays of chassis 100 in a similar manner to compute sleds 101a-n. Each of the individual storage sleds 102a-n may include various different numbers and types of storage devices. For instance, storage sleds 102a-n may include SAS (Serial Attached SCSI) magnetic disk drives, SATA (Serial Advanced Technology Attachment) magnetic disk drives, solid-state drives (SSDs), and other types of storage drives in various combinations. The storage sleds 102a-n may be utilized in various storage configurations by the compute sleds 101a-n that are coupled to chassis 100. As illustrated, each storage sled 102a-n may include a remote access controller (RAC) 113a-n. Remote access controllers 113a-n may provide capabilities for remote monitoring and management of storage sleds 102a-n in a similar manner to the remote access controllers 109a-n in compute sleds 101a-n.

In addition to the data storage capabilities provided by storage sleds 102a-n, chassis 100 may provide access to other storage resources 115 that may be installed as components of chassis 100 and/or may be installed elsewhere within a rack housing the chassis 100, such as within a storage blade. In certain scenarios, storage resources 115 may be accessed via SAS expander 106 that is coupled to backplane 105 of chassis 100. For example, SAS expander 106 may support connections to a number of JBOD (Just a Bunch Of Disks) storage drives 115 that may be configured and managed individually and without implementing data redundancy across the various drives 115. The additional storage resources 115 may also be at various other locations within the data center in which chassis 100 is installed. Such additional storage resources 115 may also be remotely located from chassis 100.

As illustrated, the chassis 100 of FIG. 1 includes a network controller 103 that provides network access to the sleds 101a-n, 102a-n installed within the chassis. Network controller 103 may include various switches, adapters, controllers, and couplings used to connect chassis 100 to a network, either directly or via additional networking components and connections provided via a rack in which chassis 100 is installed. In some embodiments, network controllers 103 may be replaceable components that include capabilities that support certain computing solutions, such as network controllers 103 that interface directly with network controllers from other chassis in support of clustered processing capabilities that utilize resources from multiple chassis.

Chassis 100 may also include a power supply unit 108 that provides the components of the chassis with various levels of DC power from an AC power source or from power delivered via a power system provided by the rack within which chassis 100 is installed. In certain embodiments, power supply unit 108 may be implemented within a sled that may provide chassis 100 with redundant, hot-swappable power supply units. In such embodiments, power supply unit 108 is a replaceable component that may be used in support of certain computing solutions.

Chassis 100 may also include various I/O controllers 107 that may support various I/O ports, such as USB ports that may be used to support keyboard and mouse inputs and/or video display capabilities. I/O controllers 107 may be utilized by a chassis management controller 110 to support various KVM (Keyboard, Video and Mouse) 116 capabilities that provide administrators with the ability to interface with the chassis 100.

In addition to providing support for KVM 116 capabilities for administering chassis 100, chassis management controller 110 may support various additional functions for sharing the infrastructure resources of chassis 100. In some scenarios, chassis management controller 110 may implement tools for managing the network bandwidth 103, power 108, and airflow cooling 104 that are available via the chassis 100. As described, the airflow cooling 104 utilized by chassis 100 may include an airflow cooling system that is provided by a rack in which the chassis 100 may be installed and managed by a cooling module 117 of the chassis management controller 110.

As described, components of chassis 100 such as compute sleds 101a-n and storage sleds 102a-n may include remote access controllers 109a-n, 113a-n that may collect information regarding the warranty for hardware and software systems on each sled. Chassis management controller 110 may similarly include a warranty bot 118 that tracks warranty information for chassis systems and provides an interface for users to receive intelligent assistance regarding the status of warranties associated with chassis 100. For example, warranty bot 118 may be a software application that is configured to interact with users, such as data center administrators, and to provide intelligent assistance to interpret and understand warranty issues associated with chassis 100 and its components.

In some embodiments, remote access controllers 109a-n, 113a-n may include or may be part of a baseboard management controller (BMC). As a non-limiting example of a remote access controller 109a-n, 113a-n, the integrated Dell Remote Access Controller (iDRAC) from Dell® is embedded within Dell PowerEdge™ servers and provides functionality that helps information technology (IT) administrators deploy, update, monitor, and maintain servers remotely. In other embodiments, chassis management controller 110 may include or may be an integral part of a baseboard management controller. Remote access controller 109a-n, 113a-n may be used to monitor, and in some cases manage computer hardware components of sleds 101a-n, 102a-n.

For purposes of this disclosure, an IHS may include any instrumentality or aggregate of instrumentalities operable to compute, calculate, determine, classify, process, transmit, receive, retrieve, originate, switch, store, display, communicate, manifest, detect, record, reproduce, handle, or utilize any form of information, intelligence, or data for business, scientific, control, or other purposes. For example, an IHS may be a personal computer (e.g., desktop or laptop), tablet computer, mobile device (e.g., Personal Digital Assistant (PDA) or smart phone), server (e.g., blade server or rack server), a network storage device, or any other suitable device and may vary in size, shape, performance, functionality, and price. An IHS may include Random Access Memory (RAM), one or more processing resources such as a Central Processing Unit (CPU) or hardware or software control logic, Read-Only Memory (ROM), and/or other types of nonvolatile memory. Additional components of an IHS may include one or more disk drives, one or more network ports for communicating with external devices as well as various I/O devices, such as a keyboard, a mouse, touchscreen, and/or a video display. As described, an IHS may also include one or more buses operable to transmit communications between the various hardware components. An example of an IHS is described in more detail below.

The hardware and software components of sleds or IHSs 101a-n, 102a-n may be sourced from one or more vendors and may be supported under various warranty agreements. The warranties for the hardware and software components allow IT personnel, such as a data center administrator, to ensure that chassis 100 and components of sleds 101a-n, 102a-n perform within the certain SLAs. Warranties typically provide various levels of support comprising different response times. The availability of certain warranties may depend, for example, upon data center location relative to the vendor's support personnel or other supply chain issues. If a hardware or software component breaks down or is not functioning, then the associated warranty must provide service, such as repair or replacement, within the SLA requirements that the data center has with its customers. For example, critical workloads should generally be assigned to sleds or IHSs 101a-n, 102a-n having warranties with the fastest repair/replacement times to ensure that the IHSs 300 are available for the assigned workloads.

In one embodiment, a data center administrator or other IT personnel may use a warranty bot 118 on a chassis management controller 110 get warranty information for the IHS hardware and software. Warranty bot 118 may be a software agent (also referred to as a chat bot) to receive information about a warranty issue associated with a chassis 100 or IHSs 101a-n, 102a-n, use machine learning to parse the information, select or create a script (based on the parsed information) from multiple scripts, execute the script to interpret the warranty, and provide recommendations and assistance to a user. For example, warranty bot 18 may explain the impact of and difference between various service levels, explain what is within the scope of a warranty or what is not covered, identify contact information for warranty or service assistance, and the like.

Although warranty bot 118 is shown as a component of chassis management controller 110 in the example system illustrated in FIG. 1, it will be understood that the warranty bot application may be hosted on any appropriate server and may be run as a stand-alone application or may be a component of a remote access controller or baseboard management controller on a server. A user may access warranty bot 118 directly, such as through a management console, or through a remote connection via a network or cloud.

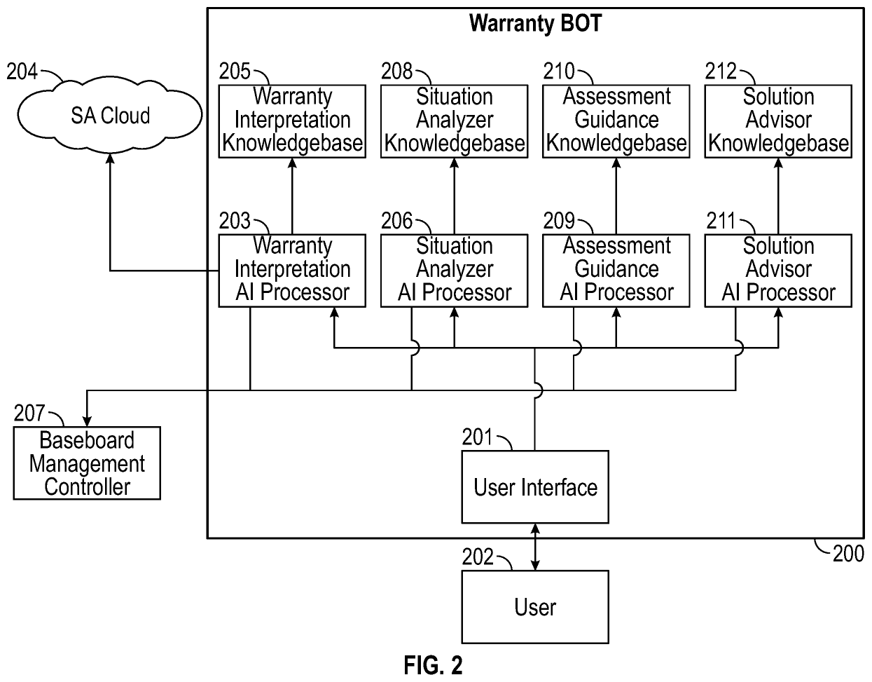

FIG. 2 illustrates a warranty bot system 200 for interacting with users to provide IHS warranty information. Users often need to contact customer support representatives to engage in one-to-one communication regarding service and warranty issues. Seamless interaction and high availability is important for the user's experience. However, a large staff is required to provide continuous availability for users. Many companies use bots or chatbots that are designed to provide support to customers for general information. A user can ask the chatbot questions, usually using a text interface, and receive answers to those questions from the chatbot. Existing chatbots are typically used for scheduling service calls or providing general contact information but are not capable of providing relevant warranty information that is targeted to a user's particular hardware or software.

Warranty bot 200 may include a conversational bot or chatbot software application. The software may have knowledge of a customer's hardware and software configuration for an IHS, server, chassis, or data center, warranties for the hardware and software, service entitlements, geography, internal product and service names, and the like. Warranty bot interface 201 provides a text-based or spoken interface to user 202, such as a text-based or speech-based interface that is capable of receiving user queries regarding warranty issues and presenting relevant warranty information. For example, warranty bot 200 may receive a query regarding a particular product ID or service tag or receive a request for assistance with a particular hardware or software failure or error message. Warranty bot 200 may retrieve warranty data and past service history for the user 202 or for specifically identified systems or components. Warranty bot 200 may then map issues, such as failures or error messages, to known knowledgebase solutions and provide user 202 with feedback regarding relevant warranty issues, such as warranty type, warranty replacement SLA (e.g., next business day (NBD), second business day (SBD), four hours (4H), eight hours (8H), mission critical (MC), etc.), support type available (e.g., level one, two, or three (L1, L1+L2, L1+L2+L3), Post Support, or other support), and/or warranty start and end dates.

Warranty bot 200 may interact with a one or more artificial intelligence (AI) processors to provide warranty information to user 202. The AI processors execute software instructions that operate to combine large amounts of data with fast, iterative processing and intelligent algorithms, which thereby allow the software to automatically learn from patterns and features in the data. AI processors may use machine learning, which automates analytical model building using methods from neural networks and statistics to find insights into data without explicitly programming regarding what to look for and what to conclude. A neural network is made up of interconnected units that processes information by responding to external inputs and relaying information between each unit. The process may require multiple iterations processing the data to find connections and derive meaning from unstructured data. The AI processors may use advanced algorithms to analyze large amounts of data faster and at multiple levels. This allows intelligent processing for identifying and predicting rare events, understanding complex systems, and identifying unique scenarios. The AI processors may use application programming interfaces (APIs) to add functionality to existing systems and software. The AI processors can reason on input data and output an explanation of the data. The AI processors may provide human-like interactions and offer decision support for specific tasks.

Warranty interpretation AI processor 203 collects information, such as the service tag of a server, and then connects to SA cloud 204 and extracts warranty details associated with that server or other component requiring service or repair. Warranty interpretation AI processor 203 then processes the warranty details and converts the information into a human-readable message that can be presented to user 202 by warranty bot interface 201. Warranty interpretation AI processor 203 may also access warranty interpretation knowledgebase 205 to interpret the warranty details and to convert them to a format that will be understood by user 202.

Situation analyzer AI processor 206 collects logs for the server from baseboard management controller 207. If the server has warranty components at the software layer, then logs from the server may also be extracted. Situation analyzer AI processor 206 then processes the logs and extracts relevant topics, such non-responsive tasks or processes and system halts due to operating system or application exceptions, such as a system crash, kernel error, stop error, or frozen system, which may be referred to colloquially as the “Blue Screen of Death” (BSOD). Situation analyzer AI processor 206 may access a situation analyzer knowledgebase 208 and look for matching topics. If the topics are covered by the warranty, then warranty bot interface 201 notifies user 202. Situation analyzer AI processor 206 may also look for whether there are any limitations based on the support types covered by the warranty, which is also notified to user. For example, a BSOD may be covered by an L1-L2-L3 warranty but not an L3 warranty, and so user 202 would be notified of no coverage if the warranty for the server was L3.

Assessment guidance AI processor 209 receives information from situation analyzer AI processor 206 and looks for requests from user 202 for specific details, such as whether a part can be replaced, whether L1/L2/L3 support is available, etc. Based on the information from situation analyzer AI processor 206, assessment guidance AI processor 209 looks up warranty artifacts, such as terms and conditions, and determines whether the warranty meets the user request. The assessment guidance AI processor 209 then directs warranty bot interface 201 how to respond to the request from user 202. Assessment guidance AI processor 209 may access an assessment guidance knowledgebase 210 to interpret warranty assets or to determine how to respond to user 202.

Solution advisor AI processor 211 mines previous case logs for other users and identifies potential timelines for cases with similar topics. Solution advisor AI processor 211 may access a solution advisor knowledgebase 212 for information regarding previous service issues for similar topics. Solution advisor AI processor 211 also looks for similarities between the current situation as well as what was observed in the past, such as time to repair and success of repair for similar issues. Based on the similar past cases, solution advisor AI processor 211 directs warranty bot interface 201 to provide a confidence level to user 202 as to whether they should look for a backup or not (e.g., whether to move a workload to another server or if the repair timeline meet a customer's expected SLA).

Warranty bot 200 extends standard bot or intelligent assistant interactions by providing additional, specific warranty context through situation analysis. Warranty bot 200 uses topic-based analysis to determine whether a scenario is vendor-supported or not. Using warranty artifacts, such as terms and conditions, warranty bot 200 maps the user's current situation to past cases to determine whether the warranty SLA is realizable or not. Analysis of prior logs provides an estimate for the user, who can plan for backup options if required. In some embodiments, the warranty bot 200 can access real-time service response times from the vendor, which allows the user to make backup plans based upon the exact turnaround from the vendor.

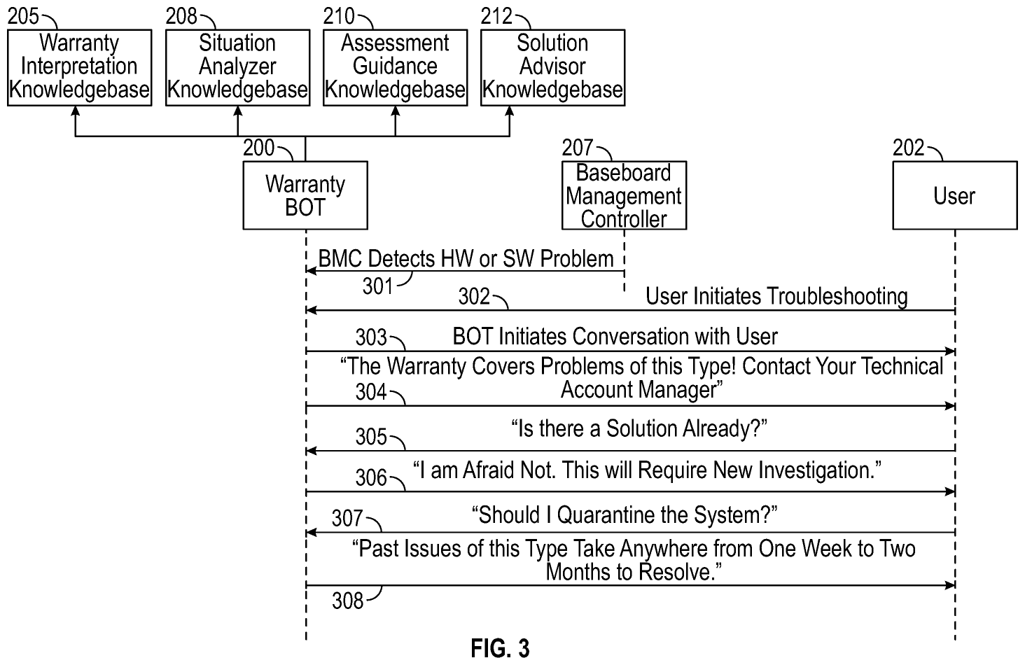

FIG. 3 illustrates an example interaction between warranty bot 200 and user 202. Warranty bot 200 may be initiated automatically when a baseboard management controller 207 detects a hardware or software problem on an IHS, such as a BSOD. In step 301, baseboard management controller 207 notifies warranty bot 200 of the problem, which initiates communication with user 202. Alternatively, in step 302, user 202 may trigger communication with warranty bot 200 by initiating troubleshooting. In step 303, warranty bot 200 may then initiate a conversation with user 200 using messaging tools for high critical servers or via a troubleshooting session using a remote access controller. Based upon information provided in step 301 or 302, warranty bot 200 will access knowledgebases 205, 208, 210, 212 using AI processors 203, 206, 209, 211. After analyzing the relevant warranty, in step 304, warranty bot 200 may notify user 202 that the warranty covers the current problem and recommend that user 202 contact a technical account manager for service assistance.

In another embodiment, in step 305, user 202 may ask whether there is a known solution available for the current problem. Again, based on AI processing and the information in knowledgebases 205, 208, 210, 212, warranty bot 200 may respond in step 306 that no solution is available. In step 307 the user may inquire further regarding what action to take, such as quarantining the server (i.e., preventing new workloads from starting) or moving workloads off the server. In response, in step 308, warranty bot 200 may provide a timeline based upon past responses to similar problems so that the user can decide whether the system needs to be isolated or if can remain in production but in a non-critical path.

In an example embodiment, an interactive warranty information system comprises a processor and a memory coupled to the processor. The memory has program instructions stored thereon that, upon execution by the processor, cause the system to communicate with a user to identify a component of interest, wherein the component is part of an IHS; and retrieve a warranty associated with the component and, using artificial intelligence processing, convert warranty details to a human-readable message. The system is further configured to collect event logs associated with the component and, using artificial intelligence processing, extract fault-related topics from the event logs; analyze the topics in view of warranty parameters using artificial intelligence processing to determine whether the fault-related topics are covered by the warranty; and notify the user whether the fault-related topics are covered by the warranty and identify any coverage limitations. The component of interest may be one or more of an IHS, an IHS hardware component, and an IHS software component. The event logs may be collected from a controller on an IHS associated with the component of interest. The human-readable message may be one or more text strings.

The program instructions may further cause the system to receive queries from the user regarding warranty coverage for specific features; assess the warranty, using artificial intelligence, and determine whether the warranty provides coverage for the specific features; and notify the user whether the specific features are within a warranty scope.

The program instructions may further cause the system, using artificial intelligence, to identify service records comprising topics that are related to the fault-related topics; analyze the identified service records to determine a potential timeline for addressing the fault-related topics; and notify the user of the potential timeline.

The warranty details may comprise one or more of warranty terms, warranty conditions, a warranty type, an SLA, a support type available, a warranty start date, and a warranty end date.

The fault-related topics may correspond to log entries that are related to errors associated with the component of interest.

In another embodiment, an information handling system comprises a memory configured to store software instructions associated with a warranty bot application and one or more processors coupled to the memory. The processors are configured to receive one or more messages of a chat conversation and to respond to the messages with warranty information. The system further comprises a warranty knowledge AI processor, a situation analyzer AI processor, an assessment guidance AI processor; and a solution advisor AI processor.

The warranty knowledge AI processor may be configured to analyze warranty content and to create human-readable messages based upon the warranty content. The warranty knowledge AI processor may further be configured to retrieve a warranty for analysis based upon a component identifier provided by a user.

The situation analyzer AI processor may be configured to analyze event logs associated with a component of interest and extract topics from the event logs and to identify topics that are relevant to warranty coverage. The situation analyzer AI processor may further be configured to notify a user of any warranty limitations based upon support types covered by a warranty.

The assessment guidance AI processor may be configured to identify user queries in the chat messages. The queries may comprise, for example, issues relating to the scope of warranty coverage. The assessment guidance AI processor may be configured to respond to the queries by confirming whether or not the issues are within the scope of warranty coverage. The assessment guidance AI processor may be further configured to provide a user with a reason why an issue is not within warranty coverage.

The solution advisor AI processor may be configured to analyze prior case records, identify past situations that correspond to a user's current situation, and notify the user of an expected timeline to resolve the current situation. The solution advisor AI processor may be further configured to notify a user whether a component of interest should be used for certain workloads prior to completion of service or repair.

The chat conversation and response messages may be related to a particular server and a warranty associated with the particular server. The warranty knowledge AI processor may be configured to interpret the warranty, and the situation analyzer AI processor may be configured to identify issues in a server event log and to determine if the issues are within warranty coverage.

The chat conversation and response messages may be related to a particular server and a warranty associated with the particular server. The assessment guidance AI processor may be configured to anticipate user queries regarding warranty coverage, and the solution advisor AI processor may be configured to notify a user when workloads on the particular server should be moved to another IHS.

It should be understood that various operations described herein may be implemented in software executed by logic or processing circuitry, hardware, or a combination thereof. The order in which each operation of a given method is performed may be changed, and various operations may be added, reordered, combined, omitted, modified, etc. It is intended that the invention(s) described herein embrace all such modifications and changes and, accordingly, the above description should be regarded in an illustrative rather than a restrictive sense.

Although the invention(s) is/are described herein with reference to specific embodiments, various modifications and changes can be made without departing from the scope of the present invention(s), as set forth in the claims below. Accordingly, the specification and figures are to be regarded in an illustrative rather than a restrictive sense, and all such modifications are intended to be included within the scope of the present invention(s). Any benefits, advantages, or solutions to problems that are described herein with regard to specific embodiments are not intended to be construed as a critical, required, or essential feature or element of any or all the claims.

Unless stated otherwise, terms such as “first” and “second” are used to arbitrarily distinguish between the elements such terms describe. Thus, these terms are not necessarily intended to indicate temporal or other prioritization of such elements. The terms “coupled” or “operably coupled” are defined as connected, although not necessarily directly, and not necessarily mechanically. The terms “a” and “an” are defined as one or more unless stated otherwise. The terms “comprise” (and any form of comprise, such as “comprises” and “comprising”), “have” (and any form of have, such as “has” and “having”), “include” (and any form of include, such as “includes” and “including”) and “contain” (and any form of contain, such as “contains” and “containing”) are open-ended linking verbs. As a result, a system, device, or apparatus that “comprises,” “has,” “includes” or “contains” one or more elements possesses those one or more elements but is not limited to possessing only those one or more elements. Similarly, a method or process that “comprises,” “has,” “includes” or “contains” one or more operations possesses those one or more operations but is not limited to possessing only those one or more operations.

What is claimed is:

1. An interactive warranty information system, comprising:
a processor; and
a memory coupled to the processor, the memory having program instructions stored thereon that, upon execution, cause the system to:
communicate with a user to identify a component of interest, wherein the component is part of an Information Handling System (IHS);
retrieve a warranty associated with the component and, using artificial intelligence processing, convert warranty details to a human-readable message;
collect event logs associated with the component and, using artificial intelligence processing, extract fault-related topics from the event logs;
analyze the topics in view of warranty parameters using artificial intelligence processing to determine whether the fault-related topics are covered by the warranty; and
notify the user whether the fault-related topics are covered by the warranty and identify any coverage limitations.

2. The interactive warranty information system of claim 1, wherein the program instructions further cause the system to:
receive queries from the user regarding warranty coverage for specific features;
assess the warranty, using artificial intelligence, and determine whether the warranty provides coverage for the specific features; and
notify the user whether the specific features are within a warranty scope.

3. The interactive warranty information system of claim 1, wherein the program instructions further cause the system to:
using artificial intelligence, identify service records comprising topics that are related to the fault-related topics;
using artificial intelligence, analyze the identified service records to determine a potential timeline for addressing the fault-related topics; and
notify the user of the potential timeline.

4. The interactive warranty information system of claim 1, wherein the component of interest is one or more of an IHS, an IHS hardware component, and an IHS software component.

5. The interactive warranty information system of claim 1, wherein the event logs are collected from a controller on an IHS associated with the component of interest.

6. The interactive warranty information system of claim 1, wherein the human-readable message is one or more text strings.

7. The interactive warranty information system of claim 1, wherein the warranty details comprise one or more of warranty terms and conditions, a warranty type, a replacement service level agreement (SLA), a support type available, a warranty start date, and a warranty end date.

8. The interactive warranty information system of claim 1, wherein the fault-related topics correspond to log entries that are related to errors associated with the component of interest.

9. An information handling system (IHS) comprising:
a memory configured to store software instructions associated with a warranty bot application; and
one or more processors coupled to the memory, the processors configured to receive one or more messages of a chat conversation and to respond to the messages with warranty information, wherein the system further comprises:
a warranty knowledge artificial intelligence (AI) processor;
a situation analyzer AI processor;
an assessment guidance AI processor; and
a solution advisor AI processor.

10. The IHS of claim 9, wherein the warranty knowledge AI processor is configured to analyze warranty content and to create human-readable messages based upon the warranty content.

11. The IHS of claim 10, wherein the warranty knowledge AI processor is further configured to retrieve a warranty for analysis based upon a component identifier provided by a user.

12. The IHS of claim 9, wherein the situation analyzer AI processor is configured to analyze event logs associated with a component of interest and extract topics from the event logs and to identify topics that are relevant to warranty coverage.

13. The IHS of claim 12, wherein the situation analyzer AI processor is further configured to notify a user of any warranty limitations based upon support types covered by a warranty.

14. The IHS of claim 9, wherein the assessment guidance AI processor is configured to identify user queries in the chat messages, wherein the queries comprise issues relating to the scope of warranty coverage, and to respond to the queries by confirming whether or not the issues are within the scope of warranty coverage.

15. The IHS of claim 14, wherein the assessment guidance AI processor is further configured to provide a user with a reason why an issue is not within warranty coverage.

16. The IHS of claim 9, wherein the solution advisor AI processor is configured to analyze prior case records and to identify past situations that correspond to a user's current situation and to notify the user of an expected timeline to resolve the current situation.

17. The IHS of claim 16, wherein the solution advisor AI processor is further configured to notify a user whether a component of interest should be used for certain workloads prior to completion of service or repair.

18. The IHS of claim 9, wherein the chat conversation and response messages are related to a particular server and a warranty associated with the particular server, and wherein the warranty knowledge AI processor is configured to interpret the warranty, and the situation analyzer AI processor is configured to identify issues in a server event log and to determine if the issues are within warranty coverage.

19. The IHS of claim 9, wherein the chat conversation and response messages are related to a particular server and a warranty associated with the particular server, and wherein the assessment guidance AI processor is configured to anticipate user queries regarding warranty coverage, and the solution advisor AI processor is configured to notify a user when workloads on the particular server should be moved to another IHS.
